(19) United States
(12) Patent Application Publication
(10) Pub. No.: US 2002/0189632 A1
(43) Pub. Date: Dec. 19, 2002

(54) Method of removing deposits of material formed in laser machining

(76) Inventors: Armin Glock, Urbach (DE); Konrad Koeberle, Backnang (DE); Anke Mueller, Markgroeningen (DE); Juergen Hackenberg, Sachsenheim (DE)

Correspondence Address: KENYON & KENYON, ONE BROADWAY, NEW YORK, NY, 10004, US

(21) Appl. No.: 10/093,929

(22) Filed: Mar. 7, 2002

(30) Foreign Application Priority Data
Mar. 7, 2001 (DE) 101 10 823.0

(51) Int. Cl. B08B 3/08; B08B 3/12

(52) U.S. Cl. 134/1; 134/3; 134/28; 134/41

(57) ABSTRACT

A method of removing deposits of material which are formed in laser machining is described. The deposits are removed by at least one of the methods—pickling method and/or electropolishing method.

### BACKGROUND INFORMATION

The present invention relates to a method of removing deposits of material which are formed in laser machining according to the type defined in greater detail in the preamble of claim 1.

In laser machining of metallic materials in particular, a large amount of energy is introduced into the material to be machined, resulting in melting and in some cases vaporization of the metal or alloy. The vaporized and/or molten material is usually displaced out of the machining area by the input of laser energy and then is deposited in an edge area or adjacent areas of the machining zone, where it solidifies.

Laser machining is generally performed with supporting gas jets, using mixtures with air or mixtures of oxygen, nitrogen, argon, etc. in various ratios, depending on the laser machining operation. Thus, accumulations of molten metal and/or oxides or nitrides in various percentage ratios occur in the edge area of the material zone machined with a laser, depending on the gas used in the process.

Essentially, depending on the gas used, the oxidic and metallic portions of the deposits of material may be in various arrangements on the component to be machined. For example, the deposit may be formed from a metallic melt underlayer and an oxidic cover layer. Likewise, a metallic layer and an oxidic layer may also be situated side by side on the component.

Such deposits of material may also be in various forms. In laser drilling, for example, accumulations of material in the form of “volcanic cones” and burrs of cast-off material may be formed mainly around the edge of the laser-cut hole.

These uncontrolled accumulations of material on a laser-machined component are undesirable, however, because they alter the machining geometry and thus also the geometry of the component itself. It is a disadvantage that the geometry of the surface of the component having such unwanted irregularities is difficult to determine in advance.

Another negative effect of such deposits of material is their uncontrollable adhesion to the surface of the component, so that under some circumstances there may be uncontrolled detachment of particles. The deposits of material may also entrain pieces out of the surface of the component in a detachment process.

A laser machining method in which deposits of material may be formed would include the single-pulse method of mass producing boreholes, for example. This is usually performed by high-speed laser drilling.

In single-pulse drilling, holes of different depths are produced, depending on the pulse time, time intensity curve and focusing, the diameters of these holes possibly being somewhat smaller or larger than the diameter of the focused beam, depending on the choice of parameters. Typical data for the boreholes include a diameter of less than 0.5 mm and a depth of less than 2 mm with diameter tolerances of +15 μm and roughness values of approximately the same order of magnitude for the wall of the borehole.

Another laser machining method in which deposits of material may be formed is the twist drilling technology or the thread tapping technology in which it is possible to produce micro-precision bores by precision laser drilling methods.

In addition to laser drilling, such deposits of material also occur in microstructuring of metal and alloys when this structuring is performed with the help of a laser, e.g., to produce indentations or grooves. Such deposits are also a disadvantage in particular when the grooves are situated close together and should have very accurate dimensions.

So far in practice, such unwanted deposits of material have either not been removed at all and therefore have been left on the component, or mechanical methods have been used to remove these deposits. For example, grinding, brushing and/or high-pressure water jet deburring are used for this purpose.

However, these mechanical methods have the disadvantage that they may lead to smearing of material in the machining zone at the surface of the component or they may result in the burrs of cast-off material being forced back into the machining zone. In addition, it is even possible for the mechanical method to result in uncontrolled detachment of material in the molten edge area of the machining zone.

### ADVANTAGES OF THE INVENTION

The disadvantages described above are avoided to advantage with a method of removing deposits of material that are formed in laser machining, according to the features of the preamble of claim 1, where deposits of material are removed by at least one of the methods, namely pickling processes and/or electropolishing methods.

It has been found that mainly oxidic and nitridic portions of the deposits of material are removed in a pickling treatment on metallic workpieces. After a pickling treatment, only metallic deposits remain on the surface of the component.

In the case of a component to be machined by laser, the material is usually metal in a pure form or as an alloy. However, it would essentially also be conceivable to use the method according to the present invention with other materials such as ceramics.

In the case of thick oxidic and/or nitridic deposits in particular, it is advantageous if the pickling treatment is supported by ultrasound. Thus, essentially complete removal of the oxidic and/or nitridic portions of the deposits of material may be accomplished better and more rapidly.

In an advantageous embodiment of the method according to the present invention, the pickling solution could be placed in a vibrating pan, for example, whose walls are vibrated, so that the pickling solution is also vibrated. In addition, it would be equally possible to introduce a bar-type sonotrode into the pickling solution to induce vibration in the solution.

According to a preferred embodiment, pickling is performed in a dilute pickling solution of sulfuric acid and phosphoric acid plus surfactants, preferably at approx. 70° C.

The metallic melt deposits that are exposed in pickling by removal of the oxidic and/or nitridic components of the deposits are then removed in an electropolishing method according to a preferred embodiment of the present invention.

The electropolishing method operates without force and completely prevents unwanted smearing of material and detachment of material such as that which occurs in methods according to the related art.

In electropolishing, the component to be freed of deposits is connected as an anode in an electrolytic cell. Machining is then performed with a d.c. current or a pulsed current by using the method with which those skilled in the art are familiar per se.

According to another preferred embodiment of the present invention, electropolishing is performed in an electrolyte of concentrated sulfuric acid and phosphoric acid. A preferred temperature for performing electropolishing is approx. 60° C.

Depending on the type, amount and ratio of the deposits of material, the processing duration of the pickling step and the electropolishing step are adapted individually.

In special cases, one of the two processing steps, i.e., the pickling process or electropolishing, may be omitted. Thus, for example, it is conceivable that a processing by electropolishing may be sufficient when there are minor amounts of oxidic deposits on the component and primarily metallic components in the deposits of material, without having to perform pickling in advance.

The method according to the present invention has proven to be advantageous in particular when used for removal of material after laser drilling, e.g., when creating boreholes in filters of a control valve or in a nozzle head of a fuel injector.

Additional advantages and advantageous embodiments of the object of the present invention are derived from the description, the attached drawing and the patent claims.

### DRAWING

Two embodiments of a method of removing deposits of material which are formed in laser machining as well as examples of laser-machined material in which there has not been any removal of material and in which removal of material according to the present invention has been performed are illustrated in the drawing and are explained in greater detail in the following description. The drawing shows:

FIG. 1: an enlarged schematic diagram of a borehole in a nozzle head after high-pressure deburring;

FIGS. 2a) through 2c): a filter of a control valve after the individual steps of the method according to the present invention, FIG. 2a) showing the filter after laser drilling, FIG. 2b) showing the filter after pickling, and FIG. 2c) showing the filter after electropolishing, each in an enlarged detail;

FIG. 3: a drum which may be used for pickling; and

FIG. 4: an enlarged borehole of a DSLA nozzle after laser drilling (FIG. 4a), after pickling (FIG. 4b) and after electropolishing (FIG. 4c).

### DESCRIPTION OF THE EXEMPLARY EMBODIMENTS

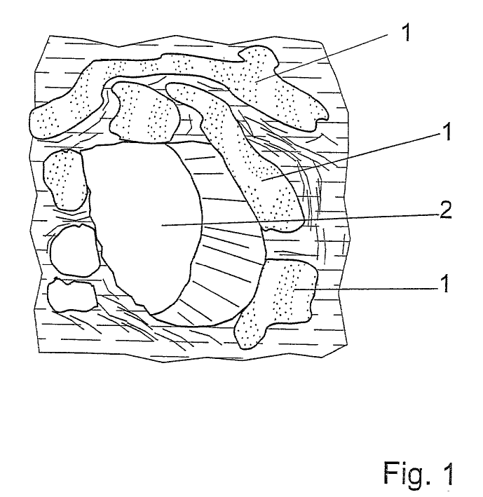

FIG. 1 shows as an example an enlarged laser borehole in a nozzle head for diesel injection, high-pressure deburring having been performed according to the known method of the related art after laser drilling. As indicated in FIG. 1, melt splatter 1 has formed in the area of the edge of the hole with a height of 30 μm and in some areas much higher around a laser-drilled injection orifice 2 of the nozzle head. Some of this melt has been partially smeared or pushed around by the high pressure deburring and has even resulted in uncontrolled detachment of material in some areas, as shown well in FIG. 1, so that the surface of the component also has uncontrolled indentations in addition to the smearing.

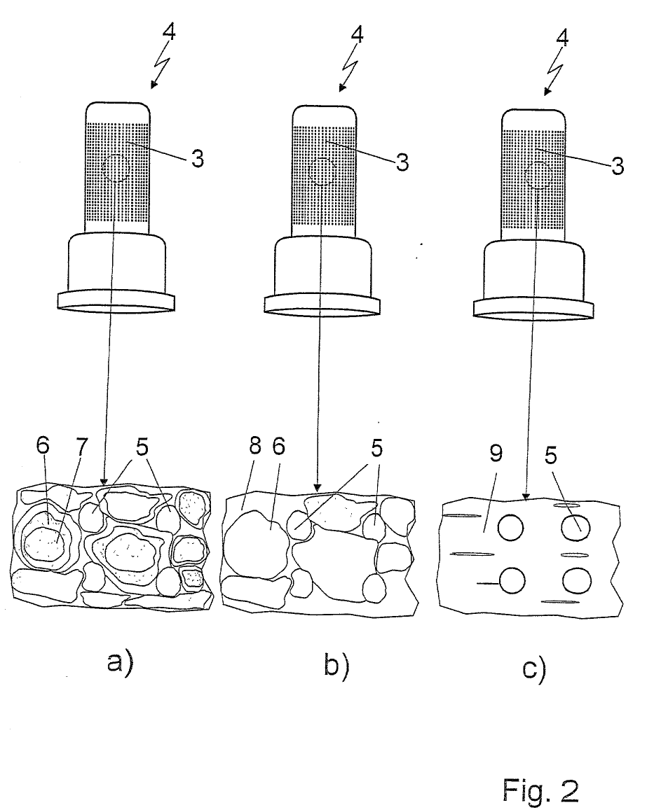

FIG. 2 shows as an example a filter 4 of a pressure regulating valve, shown here for a common rail system, filter 4 being shown in FIG. 2a) after laser drilling, in FIG. 2b) after pickling and in FIG. 2c) after electropolishing, each shown as an enlarged detail of machined area 3. In the case of a such a filter 4, approx. 2000 holes 5, each having a diameter of approx. 60 μm to 80 μm, are created in a cylindrical component made of a highly alloyed steel by high-speed laser drilling into lateral surface 3. After high-speed drilling, the entire processing are around holes 5 is covered with oxidic melt deposits 7 and metallic melt deposits 6 which form a scaly surface, which is shown in principle in FIG. 2a) and in particular in the greatly enlarged detail thereof.

After laser drilling, a pickling process is then performed according to the present invention by exposing surface 3, which is to be machined, to a conventional pickling solution, which in this case is a dilute solution of sulfuric acid and phosphoric acid together with surfactants, at 70° C. According to the preferred embodiment shown here, ultrasonic support is used here, and the pickling is performed during a processing time of approx. 15 minutes.

As indicated in FIG. 2b) the surface of filter 4 in processing area 3 is actually much smoother after the pickling process. In particular, it is apparent here that there are only holes 5 in the laser-drilled lateral surface of filter 4 and metallic melt deposits 6 on an otherwise smooth metallic component surface 8. Oxidic melt deposits 7, which are still predominant in FIG. 2a), have been removed from the surface of filter 4 here.

When electropolishing of machining area 3 is performed subsequently, it yields a metallic electropolished component surface 9 such as that illustrated in FIG. 2c). Electropolishing has been performed here in a conventional electrolyte of concentrated sulfuric acid and phosphoric acid at a temperature of 60° C. The current density according to the preferred embodiment was 5 A/dm² with a processing time of approx. 25 minutes.

Since filter 4 described here is machined over its entire surface, it is treated as bulk material in a drum in pickling and electropolishing.

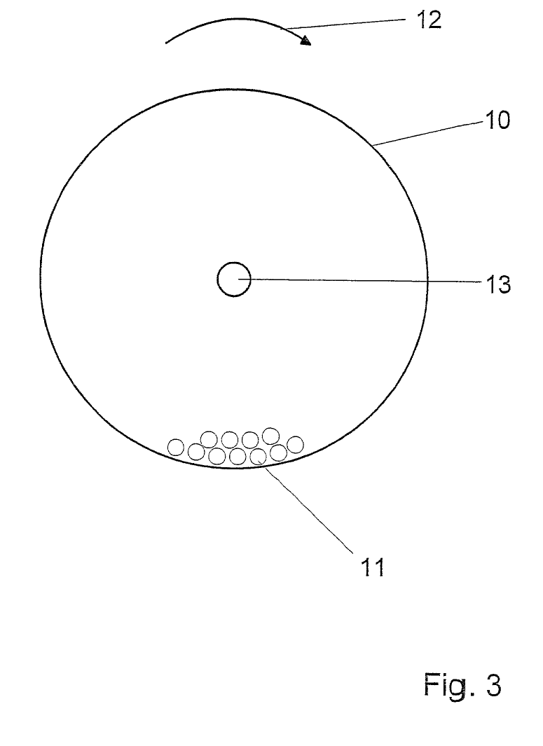

Such a drum 10 is diagramed as an example in FIG. 3. This is a drum for pickling in which parts 11 that are to be pickled are placed. Drum 10 is then rotated in the direction of arrow 12. At the same time, pickling is supported by an ultrasonic push-pull oscillator at the center of drum 10.

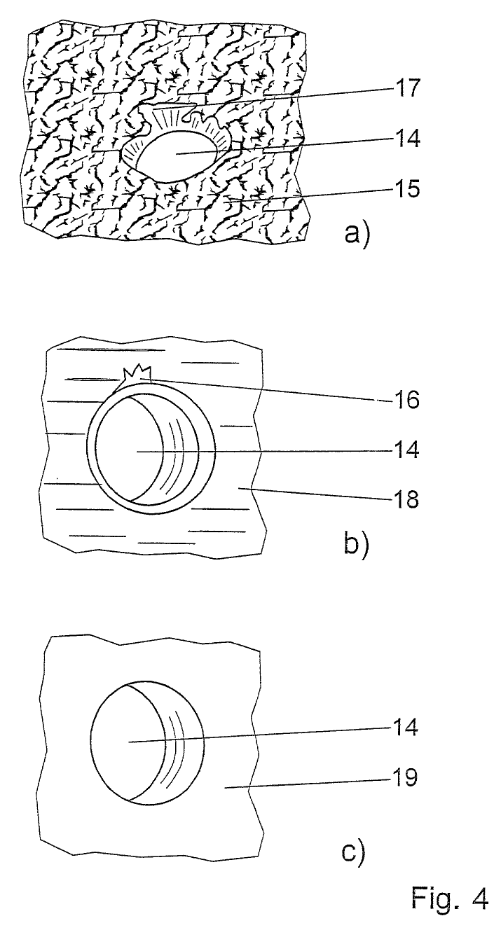

FIGS. 4a) through 4c) show a detail of a nozzle head for diesel injection, in which a nozzle orifice in the form of injection holes 14 has been laser drilled, shown here after the individual steps, namely laser drilling, pickling and electropolishing.

In the case of such a nozzle head, injection holes 14 having a diameter of approx. 100 μm are drilled in the nozzle body, made here of 18CrNi8, by precision laser drilling. Between 5 and 14 of these injection holes 14 are provided in the nozzle.

FIG. 4a) shows injection hole 14, which is illustrated here as an example after laser drilling, showing melt splatters 17 on the order of 30 μm in size in the direct area of the edge of the hole and to some extent also considerably higher. In the immediate ambient area around injection hole 14, the surface has mainly oxidic deposits 15 which impart a rough appearance with numerous elevations to the surface, which is illustrated here in high magnification. In addition, metallic melt deposits are also visible on the nozzle head, although here to a lesser extent than in the case of filter 4, which was described in greater detail with respect to FIG. 3.

In a subsequent pickling process, a conventional pickling solution, which may be a dilute solution of sulfuric acid and phosphoric acid with surfactants, may again be used, in which case the processing surface is pickled at a temperature of 70° C. with ultrasonic support for a processing time of 60 sec. Although a working temperature of at least approx. 70° C. has proven very advantageous for the pickling process, pickling may also be performed at lower temperatures.

FIG. 4b) shows that the vicinity around injection hole 14 has a much smoother surface after pickling than immediately after laser drilling, because the oxidic deposits are now no longer present. Thus, after the pickling process, there are usually only metallic melt deposits 16 on an otherwise metallic component surface 18, which now has only groove-like deformations.

The pickling process is followed by electropolishing, which is performed in a conventional electrolyte, which may be made of concentrated sulfuric acid and phosphoric acid together with alcohol, preferably at 60° C. However, this electropolishing may also take place at lower temperatures such as 25° C. The processing time for the electropolishing operation amounts to 2 min in the present case.

FIG. 4c) shows hole 2 of the nozzle head, on an enlarged scale here, after electropolishing, and it is apparent that there are no more melt splatters on the machining surface but instead there is only a metallic electropolishing component surface 19.

In this application of the method according to the present invention, only a certain area of the component is treated in pickling and electropolishing, not the entire surface of the component which is to be treated, namely the nozzle head. Therefore, the nozzle heads are processed as individual parts, not as bulk goods in a drum.

Essentially it should be pointed out that with the method according to the present invention, a typical smooth surface is produced, clearly identifying components treated by the method according to the present invention.

What is claimed is:

1. A method of removing deposits of material which are formed in laser machining,
wherein the deposits of material are removed by at least one of the methods—pickling method and/or electropolishing method.

2. The method according to claim 1,
wherein first the pickling method is performed and then the electropolishing method is performed.

3. The method according to claim 1 or 2, wherein the pickling method is supported by an ultrasound treatment.

4. The method according to one of the preceding claims,
wherein the pickling method is performed in a pickling solution which is a dilute solution of sulfuric acid and phosphoric acid with surfactants.

5. The method according to one of claims 1 through 4, wherein the pickling method is performed at a temperature of at least approximately 70° C.

6. The method according to one of claims 1 through 5,
wherein the electropolishing method is performed in an electrolyte which contains concentrated sulfuric acid and phosphoric acid.

7. The method according to one of claims 1 through 6,
wherein the electropolishing is performed at a temperature of at least approximately 60° C.

8. The method according to one of claims 1 through 7,
wherein the components to be treated are subjected individually to the pickling and/or the electropolishing method.

9. The method according to one of claims 1 through 7,
wherein the components to be treated are subjected to a pickling and/or electropolishing method as bulk goods in a drum.

10. The method according to one of claims 1 through 9,
characterized by its use for removal of an accumulation of material after laser drilling in the case of filters for a control valve.

11. The method according to one of claims 1 through 9,
characterized by its use for removal of an accumulation of material after laser drilling in the case of a nozzle body of a fuel injector nozzle.
